(19) United States
(12) Patent Application Publication
(10) Pub. No.: US 2004/0127231 A1
(43) Pub. Date: Jul. 1, 2004

(54) Location-based service protocol

(76) Inventors: Erez Dor, Rishon Le Zion (IL); Zipora Dorit Drach, Las Vegas, NV (US)

Correspondence Address: JOHN ALEXANDER GALBREATH, 2516 CHESTNUT WOODS CT, REISTERSTOWN, MD, 21136, US

(21) Appl. No.: 10/333,848

(22) PCT Filed: Jul. 23, 2001
(86) PCT No.: PCT/IL01/00679

(51) Int. Cl. H04Q 7/20

(52) U.S. Cl. 455/456.6

(57) ABSTRACT

A location based service data-communications protocol (100), the protocol (100) including the steps of: receiving a call from a communications device (120); discerning location-relevant information about a present location-cell of the communications device (130); by interrogating a database facility finding at least one authorized support authority for the present location-cell (140); and routing the call to a support authority selected from the at least one support authority (150). The caller may presently be in a fixed location or may be mobile. For a fixed location caller, a preferred embodiment relates to customer services. For a mobile caller, a preferred embodiment relates to a cellular accompaniment service transaction model, to a mobile data-communications device initiated call for the service; wherein a combination of voice and digital accompaniment is provided to the caller in conjunction with caller location-based data according to a respective degree of location based accuracy feasible for determining the caller location.

### FIELD OF THE INVENTION

Generally, the present invention relates to “on the spot type services” such as customer services. More specifically, the present invention relates to systems services that are facilitated using mobile location-based telecommunications.

### BACKGROUND OF THE INVENTION

Every large services-based company (of any type, including hotels, banks, supermarkets, fast-food chains, restaurants, etc.) share a common problem, irrespective of size or number of branches, namely, that the decision-making echelon has insufficient information about the nature, availability and quality of the service received by customers from the company representatives facing them, of any kind, including shop assistants, consultants, sales personnel, and the list goes on. Ironically, information about customer satisfaction is critical to the existence of services-based companies, and consequently, such companies spend huge sums, estimated at millions of dollars annually, to obtain any feedback whatsoever from the public, in various ways: Gathering information from customers by means of written and telephone questionnaires; Stationing a complaints box at every branch; Setting up a customer service department at every branch; or Setting up overt and covert units to check service, for example, by posing as customers.

However there is one scenario in the company-customer relationship, sometimes not lasting more than a moment, in which the customer service inspection unit is almost entirely helpless, even though the customer relationship might have extended over many years, bringing in tens of thousands of dollars. This is the scenario in which the customer is disgruntled or angry about poor service received. We are all familiar with such situations from our own experience as customers at restaurants, banks, and in fact, everywhere. When we as customers are treated badly or in an insulting manner by any business concern, we have two choices: either to complain in one of a variety of ways, or to choose the easy and simple way out, and to walk out never to return, and to use the services of a competitor from then on. This state of affairs keeps managers awake at night, the more so the more the enterprise is based on customer service; and any change for the better, even tiny, in the percentage of customers who turn to the customer service control unit and provide the managerial echelon with the opportunity to try and redress the problem, and possibly retain the complaining person as a customer, can be critical (keeping in mind that in supermarket chains, for example, net profits on turnover are often only a few percent, sometimes, only one percent of turnover, and a large number of dissatisfied customers switching to competitors can impact on the very existence of the company).

Numerous methods are currently used in providing customer service.

Some companies, especially small businesses, ignore the problem totally, mainly because of the high cost of the customer service inspection mechanism. This remains a problem, and there is a need in the art for a new and inexpensive system to resolve this problem.

Feedback leaflets—their advantage is that they are cheap, and relatively little labor time is required to process the data. However, their disadvantages are many. They provide partial information as only a few customers complete them due to their time-consuming nature, or due to a lack of faith that matters will receive serious attention. Another disadvantage is that the problem does not receive immediate attention at the time the customer has been angered, so that the damage, from the customer's perspective, is already done. Yet another problem is the danger that the feedback leaflets will be stopped at the lower management levels and not passed on, because they do not want their managerial performance seen in a bad light.

Approaching the manager on the premises—a commonly used and relatively effective option in that it at least affords management the opportunity to respond immediately and to appease the offended customer. The disadvantages are firstly that this method is not suited to every type of customer. Some tend to shy away from confrontation and prefer to walk out of the premises because of the frontal nature of such encounters. Secondly, reporting of such events generally stays at the local level, and does not enable top management to identify problems in the system and to address them, or to identify failings at local management levels.

Letter of complaint or telephone complaint to the company's customer service center. This method is not face-to-face, and also circumvents the local management level, but it is not immediate, and is of considerable bother to the customer, and sometimes an expense to him/er (sending a letter, cost of a phone call).

Another way is to try and contact the customer service center from a cellular telephone. The disadvantages of this method are:

1) Difficulty in finding the right telephone number to call, which sometimes means a further expense, calling the Telephone Company directory assistance service.

2) The passive nature of the system, which often results in the caller being given the run around and the call being passed from one department to another, which can be costly in view of high rates charged by the cellular telephone network.

3) Due to the lengthy process that this method requires, an employee might identify that a problem with a customer is liable to be transferred to higher levels, and try at the last moment either to compensate the customer, or to put pressure on the customer not to make the call. In both instances, important information may be kept from top management.

There has been much progress in the development of practical affordable cellular telephone services in recent years. A convergence of cellular telephone service concepts with customer service concepts will be necessary to appreciate many embodiments of the present invention.

Cellular carriers have long been able to know the location of a caller within their coverage area, using various techniques, such as the proximity of the cellular telephone to the receiving antenna, and various calculations on the strength of the reception by other antennas in the vicinity, but this usage was very limited, primarily due to the inability of old models of cellular telephones to receive non-voice messages. Consequently, it was mainly used by governmental authorities, such as security organs, wishing to determine the location of suspects, or to use the information to help find missing persons. In recent years, this field has seen major technological advances. Cellular telephones now have the capacity to receive and transmit text messages, in the near future, it will be possible to surf the Internet from cellular telephones, and cellular carriers all over the world have developed various services based on knowledge of the caller's location. For example, in the advertising sphere, you are notified of a special offer at a store you are passing at that moment; in the social realm, you are informed of a friend who is in the vicinity; and there are various locating services, such as locating a stolen vehicle, workers out in the open field, or pets.

Accordingly, there remains a need in the art for a convergence technology to provided added value to telecommunications based services through the use of location based parameters; thereby improving the quality of service provided.

### SUMMARY OF THE INVENTION

The present invention relates to a location based service data-communications protocol, the protocol including the steps: receiving a call from a communications device; discerning location-relevant information about a present location-cell of the communications device; by interrogating a database facility, finding at least one authorized support authority for the present location-cell; and routing the call to a support authority selected from the at least one support authority.

General variation aspects of preferred embodiments of the location based service data-communications protocol of the present invention in any grouping or combination include:

The communications device is a wireless communications device, such as one selected from the list: cellular telephone, cordless telephone, pager, personal data assistant, or the likes.

The communications device is a standard stationary location installed telephone (or as proxy thereto—a standard stationary location installed computer), and therewith a caller-telephone identification number will provide a parse-able clue to isolate the caller location; according to the area code, trunk number, switching station ID, or when used with a reverse telephone directory database.

Discerning location-relevant information about a present location-cell of the communications device includes applying means for improving the location accuracy, as will be described hereinafter.

Receiving a call includes accepting a service selection operational variation request (such as for a virtual accompaniment service, as will be described hereinafter) and wherein finding the at least one support authority includes convoluting parameters of the finding with the service selection operational variation request (such as considering that for example the caller may not want to complain to city hall about bad lighting—but have a dispatcher monitor the callers progress through the dark streets).

Wherein routing the call includes transmitting at least one control command to a peripherally related service system (such as for example to turn on additional municipal lighting in the vicinity of the caller).

Routing the call includes transmitting at least one query to a peripherally related service system (such as to a rural rescue center or to a public service dispatcher).

These general variation aspects of preferred embodiments of the location based service data-communications protocol of the present invention will be further elaborated hereinafter using non-limiting examples, accompanying drawings, scenarios of use, and operational variations.

Furthermore, the protocol of the present invention relates to a system and method (based on location identification and in compliance with the protocol) wherein a database unit is integrated in the system that enables a company representative to obtain various details from the company databases in real time, for example, details about the customer and its past contacts with the company, or examples of the successful handling of similar problems raised by other customers.

The preferred embodiment of the present invention relates to a scenario wherein there is an active instant response at the press of a single button and a resultant transmission from a cellular telephone. For example, pressing the 5 button twice, and then SEND, automatically activates the system, and from that moment on, nothing else is required of the customer, not even payment for the phone call. From the moment of the transmission, the system determines the customer's exact location, including the actual store he/she is in, and immediately transfers the call to the regional customer service department of the chain of stores, who then deal with the customer's complaint. From the customer's standpoint, the system is perfect because it is instant, effortless, automatic and does not incur any costs.

The advantages for company management are:

The immediacy—the customer is forced to complain while still on the store premises, so that the customer's complaint is dealt with before he/she walks out of the store, and with the right handling, the customer's negative feelings towards the store can be resolved. Moreover, such personal attention might even strengthen the customer—company relationship.

The customer is referred to a department competent in dealing with such matters, and able to efficiently implement company policy in this sphere. This eliminates the risk of a local employee addressing the problem incorrectly, and increasing the customer's animosity toward the store, as is currently often the case.

The simple nature of the operation required of the customer will undoubtedly lead to an increase in the percentage of customers using the option to contact customer service centers, which will also aid the gathering of information about problems throughout the chain, information that can be analyzed and used to find recurring problems, which can then be dealt with in a timely manner.

More than any other advantage to the business concern is the fact that the system can be used as a deterrent: employees at the local level mindful of the fact that the customer is a moment away from top management will be discouraged from providing poor service or service that runs counter to company directives.

The customer is not required to confront an employee face-to-face, but if he so desires, can have customer service deal with the problem, thereby avoiding an embarrassing standoff.

Another advantage is the opportunity to receive positive feedback from customers about good service, in view of the ease and cost-free nature of the process to the customer; and information about good service dispensed is no less important to corporate management

In order to consider the scope and spirit of the present invention properly in all of its many aspects, it is facile to describe the present invention as generally relating to a protocol (a protocol compliant system and method), based on location identification, for improving customer service. The system and method of the present invention includes a mobile wireless communications network capable of locating the caller's location with a determined level of accuracy. For example, the system and method enables automatic and immediate connection of a customer in a store with the central customer service department responsible for that store. This connection occurs at the very instant that the customer transmits a predetermined speed dialed code signal from the customer's cellular telephone. The system's computers identify the code and location, which automatically routes the call to the appropriate customer service destination. This eliminates the need for the customer to know and dial the telephone number of the desired customer service department.

A preferred embodiment of the present invention includes a uniform speed dial code, which is agreed worldwide or over extensive regions, such as whole countries. Furthermore, the code distribution need not be specifically geographic but, for example, extends over a chain of stores, or over several chains. In addition, within a telecommunications network, for example the International Orange network, or within a group of several networks, a uniform code is utilized.

In accordance with a further embodiment of the present invention, communication is executed from a cellular telephone over a cellular telecommunications system or network. In addition, communication is executed through an appropriate telecommunications system, for example, a satellite telephone or an MIRS (Management formation & Retrieval System) such as an email or a voice message. Communication is also executed through a wireless mobile device that is not a telephone, for example, from a hand-held computer or other portable computer equipped with a wireless communications capability.

Another embodiment of the present invention relates to communication that is partly voice or is totally another electronic communication system, for example, wireless Internet, SMS text messages and others. Generally, the reason for utilization of this type of communication system relates to customer speech or hearing limitations.

Also, locations, other than service providers, which are stores in the usual sense, includes other classifications of service providers such as municipal or national public services including, for example, post office branches, electricity utility offices, income tax offices, educational institutions, health institutions, police stations, and many others.

A variation of an embodiment of the present invention relating to agreed codes includes codes for each type of customer query, for example, for service complaints or complements. The inclusion of a variety of code-types in the system is labor saving, since a customer requiring a specific service can be handled, for example, by a cost-effective auto-attendant system, rather than by a more costly operator. Sorting of query-types is also implemented by a computerized or online operator call routing system for clarifying and providing a particular service and routing the customer accordingly.

A further embodiment of the present invention relates to call charges. Calls are billed partly or entirely to the customer's account. Alternatively, the call charges are billed partly or entirely to an account other than that of the customer, for example, to the account of the company to whom the call is made. Furthermore, added elements incorporating the integration of hardware and software automatically route customer queries to special telephone lines, for the billing of the account of the recipient of the call.

Alternative to the connection being made immediately by a customer, an additional embodiment of the present invention relates to added elements that provide that calls to a destination are delayed. For example, a computerized auto-attendant system reduces the workload on the system without giving the customer the impression that queries are being delayed. Furthermore, such a system provides sufficient time for the service company system to extract the communication history of each customer from its databases, and to make that information available to the company employee taking the call.

Another embodiment of the present invention relates to the system enabling immediate identification of the telephone number from which the customer has called. Such identification is facilitated, for example, by the caller identification service. Using this service, the customer is called back immediately, while or prior to dealt with a query. The customer is informed that the call waiting is from a customer service center, or, alternatively, is instructed to hang up, in anticipation of a return call. This change in the direction of the communication enables the service provider to continue immediate communication with the customer using an optimum channel. For example, a call from the customer's cellular telephone to the company landline telephone is generally more costly than the company calling the customer using a connection from the customer's cellular carrier.

Rather than a customer calling from a specific store, a further embodiment of the present invention relates to a service provider furnishing a non-stationary assistance. For example, a customer calls from public transporter, a bus operated by a public bus transportation system, a mini-bus, a rail transportation system, an underground subway and a tramway system. Additional examples of such transportation systems include air transportation, the customer calling from an airplane or maritime transportation, the customer calling from a ship.

A variation of an embodiment of the present invention relates to the transportation vehicle displaying a number or other identification code relating to that specific transportation vehicle within a specific transportation system. Such a display overcomes the difficulty of identifying such a vehicle, and provides the possibility of definitive identification of the vehicle by combining information received from the location-based system with the number or code given by the customer.

A further embodiment of the present invention relates to providing a permanent electronic device within or in the vicinity of the store or means of transport, to facilitate the system determining the caller's location.

A variation of the embodiment of the present invention relating to the device to facilitate determining the caller's location includes a device to establish the caller's exact location by means of a network of sensors distributed throughout a building. The sensors deliver to the processing unit in the device, data about the transmission received, enabling calculation, with the appropriate software, the whereabouts of the caller. This information is transmitted to the telecommunications system to assist in determining to where the call is to be routed. To improve the system's accuracy in determining the caller's location, sensors with a limited reception range are utilized, for example, up to ten meters. This represents the approximate reception range designated for wireless Blue Tooth systems, so that any sensor, identifying a wireless transmission in its vicinity, provides an immediate indication of the caller's location to within 10 meters. Furthermore, integrating an operator-initiated query or a computerized auto-query into the system improves the system's accuracy in determining the caller's location, specifically requiring a predetermined customer response related to each position within a prescribed area.

Another embodiment of the present invention relates to providing an immediate connection between a traveler in an unfamiliar location and a service provider in the possession of information relating to the location. The service provider is able to supply information that the traveler requires. Examples of such information include dangers the traveler is liable to encounter and the means for avoiding such danger. The intention is not a distress transmission intended for emergencies since such a system already exists. Rather, the intention is to provide a location-based system the function of which is to provide advance warning and to prevent such occurrences.

A variation of such an advanced warning system provides a means for enabling an active response to warn about dangers, by combining known information and regarding the caller's location. Each telephone in a cellular telephone network sends a transmission signal every few seconds to enable the cellular telephone system to identify the transmission location. This transmission is used to determine the location of the cellular telephone owner even when the instrument is not in use. Having established the transmission location, the system is enabled to provide a pertinent warning. For example, a warning is provided if a customer is approaching a known mine field or is liable to cross a border.

Another embodiment of the present invention relates to saving electricity in public areas. For example, in seldom-used areas, lighting is normally not provided until a code signal is actively provided by a traveler or until the system detects the presence and identifies the presence of a customer's cellular telephone. The areas serviced by such a system include public parking lots, public parks, industrial zones, alleyways, streets, road junctions and illuminated commercial and non-commercial signs. Such saving procedures include light dimming and brightening as well as for light adjustment for predetermined time periods.

An added variation of an embodiment of the present invention relates to a specifically desired service. Transmission of a predetermined code enables the system to automatically route a customer to a control center that identifies the location. The system queries the type of accompaniment the caller wishes to receive. The desired service is provided for the requested period of time, during which the service provider maintains a direct connection to whatever rescue agencies that are likely to be needed including cellular voice accompaniment when the circumstances do not justify calling a rescue agencies.

Additionally, cellular accompaniment of callers is provided on a combination of voice and digital accompaniment. For example, after an operator responds to a caller, the accompaniment is automated. The automated monitoring is conducted, for example, as the caller activates a particular button at short predetermined intervals or stating a voice password at specific intervals. If this condition is violated, a connection to a live operator is reinstated immediately, or an emergency service is initiated. Further, specific background information is furnished to the service provider. The service is of necessity matched to the specific needs of the caller, for example, children, the elderly and immigrants receive service tailored to their particular needs.

A further variation relates to cellular accompaniment of callers, the system having the means to seek help from the caller's immediate vicinity. Should fears about a particular danger materialize, using available information, for example, knowledge of the caller's location, facilitates finding assistance nearest to the caller's location on the basis of their locations have been identified by the system. One other cellular accompaniment of callers includes the service operator being connected to surveillance cameras stationed in the caller's area.

Added to the system for saving electricity in public areas in an active or passive manner, the system includes sensors related to volume, voice, movement, heat, and others.

Furthermore, the protocol of the present invention relates to a system and method (based on location identification and in compliance with the protocol) wherein the communication device in the caller's possession provides information regarding the currently in progress accompaniment process. Thereby it is possible that any additional problematic circumstances arise, for example to prevent an assault on the caller. Information regarding the currently in progress accompaniment process is executed optically, for example, by means of a blinking flashlight, by means of a repetitive tone or by vocal means.

Another variation of an embodiment of the present invention relates to the system being used to obtain information from traveling vehicles about the road network for the use of authorized authorities, for example, the police, or tax squad. Also information is retrievable regarding driver and vehicle details and cargo carried by a vehicle in order to improve supervision of the movement of goods on the road.

The system is used to obtain information whereby vehicles approaching an inspection point are instructed by a sign to transmit data to a predetermined code number. The received data is related to confirmation from the telecommunications system that the transmission indeed originated near the inspection point. The received data is compared with the data in the system, to determine whether to stop the vehicle for physical inspection. This procedure eliminates superfluous checks of vehicles that are in order, and enables improved utilization of supervisory and investigative resources.

An added variation of an embodiment of the present invention relates to the system identifying the location being separate from the actual telecommunications system. For example, communication is implemented over a cellular network, but a satellite network or pager network executes identification of the transmission location. Furthermore, the communication device is also a mobile wireless device.

Furthermore, the protocol of the present invention relates to a system and method (based on location identification and in compliance with the protocol) wherein a data-communications device (such as a cellular telephone) making it known to the surroundings that the accompaniment process is currently in progress can be used even in situations where accompaniment is not in effect (for example, in places where the system does not have reception), thereby simulating the deterrence of an actual operating system.

Those familiar with business models will readily appreciate that the protocol of the present invention will accommodate transactional sensitivity with respect to adjustments in payments, refunds, disbursements, pay schedules, and the likes. For example, the step “by interrogating a database facility, finding at least one authorized support authority for the present location-cell” may further allow differentiating between ordinary request for service (such as customer complaints, voice accompaniment, etc.) and financial adjustments. This sensitivity is easily facilitates when the database records denote if the “support authority” for ordinary transactions is the same as for financial adjustments. To complete the enabling of this business model variation, discerning location relevant information, according to the protocol of the present invention, includes discerning (even if by interactive query) additional aspects of the communications device originated call—such as the nature of the desired transaction (ordinary, financial, or otherwise). By using this additional aspect(s) the interrogation of the database may include the appropriate discernment, in the event that the results for the current location are differentiated between the aspect types.

The present invention also relates to an article of manufacture including a computer usable medium having computer readable program code embodied therein (198 in FIG. 1) for facilitating a location based service data-communications protocol transaction, the computer readable program code in said article of manufacture including: first computer readable program code for causing a computer to receive a call from a communications device; tied to the first computer readable software, second computer readable program code for causing the computer to discern location-relevant information about a present location-cell of the communications device; tied to the second computer readable software, third computer readable program code for causing the computer to find at least one authorized support authority for the present location-cell by interrogating a database facility; and tied to the third computer readable software, fourth computer readable program code for causing the computer to route the call to a support authority selected from the at least one support authority.

The present invention furthermore relates to a program storage device readable by machine, tangibly embodying a program of instructions (199 in FIG. 1) executable by the machine (100 in FIG. 1) to perform method steps for a location based service data-communications protocol including, said method steps including: receiving a call from a communications device; discerning location-relevant information about a present location-cell of the communications device; by interrogating a database facility, finding at least one authorized support authority for the present location-cell; and routing the call to a support authority selected from the at least one support authority.

### BRIEF LIST OF FIGURES

In order to understand the invention and to see how it may be carried out in practice, embodiments including the preferred embodiment will now be described, by way of non-limiting example only, with reference to the accompanying drawings, in which:

FIG. 1 illustrates a a schematic flow chart representation of the fundamental Operational Variation embodiment of the present invention, and therewith elements of the basic illustrative use scenario;

FIG. 2 illustrates a schematic flow chart representation of a system (operational variation) according to the present invention for improving service to clients based on location identification, the system (operational variation) operating solely using the locating capability of the cellular network;

FIG. 3 illustrates a schematic flow chart representation of a system (operational variation) according to the present invention for improving service to clients, based on location identification, when information from the network about the call location is insufficient to identify the place of business, from which the client is calling;

FIG. 4 illustrates a schematic flow chart representation of a system (operational variation) according to the present invention, when there are local sensors capable of supplying additional information;

FIG. 5 ilustrates a schematic flow chart representation of a system (operational variation) according to the present invention, where local sensors include technology that does not decipher the transmissions but is capable of uncovering information regarding the transmissions performed in their vicinity;

FIG. 6 illustrates a schematic flow chart representation of a system (operational variation) according to the present invention, where local sensors identify only an interruption in transmission in the vicinity of the sensors, at cellular communication designated frequencies;

FIG. 7 illustrates a schematic flow chart representation of a system (operational variation) according to the present invention wherein the client transmits only general information;

FIG. 8 illustrates a schematic flow chart representation of a system (operational variation) according to the present invention, for directing a call for referral to appropriate service personnel after identifying the caller location; and

FIG. 9 illustrates a schematic flow chart representing a system (operational variation) according to the present invention to save electricity.

### DETAILED DESCRIPTION OF THE INVENTION

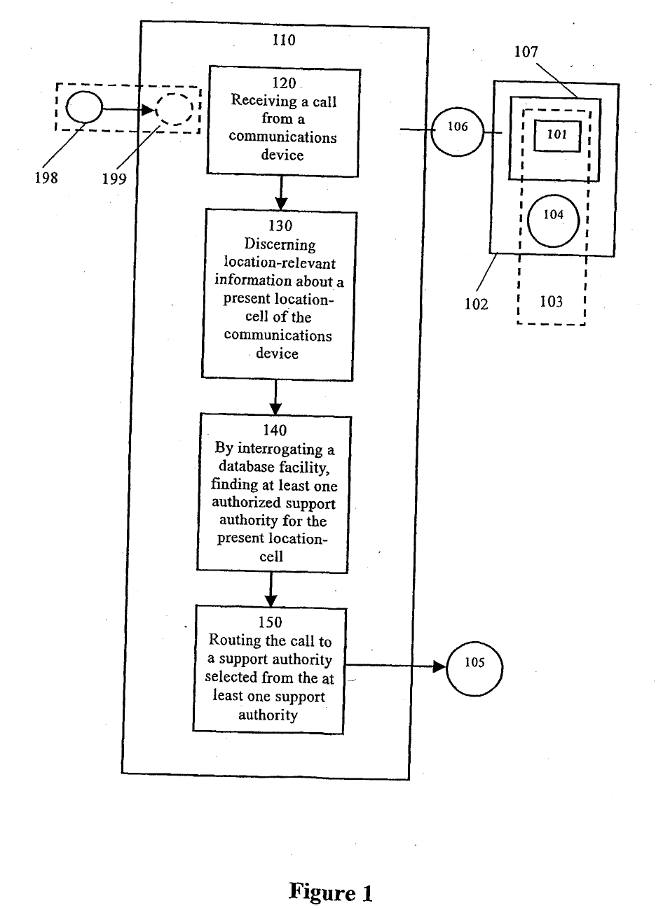

The fundamental Operational Variation embodiment of the present invention will be better appreciated with the viewing of FIG. 1; wherein is presented a schematic block diagram of to a location based service data-communications protocol 110 including protocol steps: 120 receiving a call from a communications device; 130 discerning location-relevant information about a present location-cell of the communications device; by interrogating a database facility, 140 finding at least one authorized support authority for the present location-cell; and 150 routing the call to a support authority selected from the at least one support authority.

According to a preferred scenario use embodiment of the present invention:

1. Cellular telephone 101 in the customer's possession 107 and connected to one of the wireless communications networks.

2. Wireless telecommunications network 102, capable of locating the caller with any particular degree of accuracy. All the networks have this capability, with an accuracy varying from several meters to hundreds of meters, since this is the only way they can determine to which antenna to assign a call for optimal reception levels.

3. The delineated area of the store wishing to subscribe to the service 103.

4. Preferable means for increasing the amount of information about the precise location of the transmitting cellular telephone (e.g. by triangulation, by correlation of multiple identifiable data elements, by voice recognition, by automated query and keypad response, by special device, etc). When there are many stores packed together, as in a shopping mall, or in a high rise building, the accuracy of the regular cellular network may not be sufficient to identify the actual store in which the customer is located. The function of this device is to enhance the system's accuracy. The device can use various technologies for this type of locating. For example, a device can be used that is similar to a large cellular antenna, but of reduced size in order to enable its installation in small spaces, and the call effectively transferred through it; and then, since it is nearest the transmitting location, this indicates that the call was transmitted from the delineated area within its responsibility.

Another way of increasing the system accuracy is to use a device stationed in the delineated area, equipped with two sensors, one inside the delineated area and one outside it. By comparing the differences in the transmission strengths, the system determines whether the transmission originated inside the delineated area, or outside it. Another option is to have a network of transmission strength sensors deployed throughout the building that enables precise locating of any transmission emanating from the building.

A problem may arise when several cellular telephone calls are conducted simultaneously in a store's delineated area. Therefore, in order to enable the computerized system 106 of the wireless communications network 102 to identify the correct location of the specific call meant to reach the customer service center, the information preferably transmitted from the special device 104 must be transmitted instantly, the moment any transmission is initiated, enabling the computer system to determine whether the location information is relevant to the call or can be ignored.

5. A telecommunications center operated by the company or someone on its behalf, which will handle the receipt and storage of calls for later analysis 105.

6. A computerized system combining hardware and software 106, which might be situated in the wireless network's computer 102, and whose task it is to match the information received about the caller's location with the telecommunications destination sought by the caller based on the code transmitted, and by matching the items of information, route the call to the appropriate destination, despite the lack of the specific telephone number of that destination.

Alternatively explained, the protocol of the present invention relates to a System compliant with the protocol of the present invention and a typical scenario for its Method of Use; as is forthwith described.

1. All the customer 107 is required to do is key into the cellular telephone 101 the universal code agreed by the cellular carriers and press SEND, while still in the delineated area of the store 103.

2. The cellular network, 102, by means of its computer system 106, identifies the transmitted code.

3. The computer system 106 examines the data on the caller's location.

4. When information about the location of the communication is not sufficient for the system to determine where to route the call to, the system makes use of the special device 104 located within the delineated area of the store 103, and receives additional information from it that enables the customer's location to be determined with greater accuracy.

5. After matching the items of information, and drawing a conclusion about the operation that is required, the call is routed to the customer service department of the company that owns the store 105 for customer handling.

NOTE: In order to better appreciate the present invention according to some of its more interesting aspects and preferred embodiments, immediately hereinafter are presented numerous scenarios of use; and thereinafter are presented a plurality of other operational variation embodiments of the present invention.

Additional uses for the system of the present invention as value-added mobile location-based services relate to Pressing an agreed button (worldwide, or throughout a specific country—as is already common standard practice for directory assistance or for requesting emergency services) can send you information about dangers in the region you are in, information that can save hundreds of lives a year, especially in the case of tourists who are not aware of regional dangers in following spheres:

Land or marine predators.

Creatures dangerous to humans, such as snakes, and how to keep out of their way.

Disease-carrying parasites.

Characteristic diseases of the region, and means of protection.

Risk of avalanches, especially for skiers liable to ski down a dangerous slope without being aware of the danger.

Contaminated water unfit for drinking.

Water too polluted to swim in.

Risk of infection and diseases from eating local animals, such as fish from polluted rivers.

Mine fields.

Regional conflicts.

Radiation contaminated areas.

Prevalence of robbers or bandits.

Whirlpools, shoals and strong currents.

Extreme weather conditions.

Shallow waters or rocks—jumping prohibited.

Risk of chasms and mine pits in the area, etc.

The system can be much more efficient if it is active and notifies you of the dangers facing you immediately upon your entry into a region, such as in the case of a mine field, for example.

According to another embodiment of the present invention, a similar system is adapted to the public transportation system i.e., you dial to a separate number that identifies you as a passenger traveling on public transportation. Then, based on your location and prior knowledge of the location of public transportation vehicles, you are assigned to the appropriate customer service center (to prevent errors, the use of an automatic call distribution system might be needed that prompts for additional details, for example, whether you are on Bus No. X or Bus No. Y which are traveling close to one another; or alternatively, each transportation vehicle will have a clearly visible unique number enabling its accurate identification). This system has a safety aspect, since it can be assumed that the driver of a public transportation vehicle, cognizant of the fact that any passenger can call his superiors, will think twice before committing traffic offenses or driving in a reckless manner 105.

According to further embodiment of the present invention, A similar system designed to save electricity on street lighting in areas where there is no vehicle traffic late at night. For example, upon entering a deserted industrial zone, the street lighting is off or only half the lights are on; pressing an agreed button on the cellular telephone signals your presence to an automated system, and the appropriate street lights illuminate. Another way of activating this system is to continuously track your location and turn on the lights a kilometer in front of you and turn them off immediately behind you. Such a system would enable huge savings in energy costs throughout the world.

According to still another embodiment of the present invention, The system could also be used to tighten supervision of the transportation of illegal goods such as contraband, foodstuffs without veterinary approval, etc., in the following manner: law enforcement agency stations are positioned along the roadways. A sign posted a short distance in front of the station instructs drivers of commercial vehicles and trucks to transmit an ID message containing the vehicle's details, including verification that the vehicle has passed all the licensing tests, and also full details about the cargo, including reference to the delivery note completed when the vehicle started out on its journey to the destination, a cellular copy of which was sent to the central computer at the law enforcement agencies. The officers at the roadblock check that the message received matches the details of the approaching vehicle (registration number, model, color, etc.), verify according to the cellular network's computers that the transmission indeed originated in their vicinity and from the telephone number registered as belonging to that vehicle, and check the probability that the cargo is indeed the cargo on the vehicle. There is always the option of stopping the vehicle and checking that the cargo matches, not the paperwork which could be forged, but the records on their computer system. Naturally, there is also the option of checks by patrol cars and covert checks seeking information about commercial vehicles traveling alongside them on the roads. There is yet another option in which the transmission is activated automatically by virtue of the vehicle location proximity to the law enforcement station or the law enforcement vehicle.

According to yet another embodiment of the present invention, another use is as a cellular accompaniment system. Everyone, of all ages, have some moments in their lives when they have greater fear for their safety, maybe when walking through dark areas or through dangerous and unfamiliar surroundings. These are not instances of real danger, when one would raise the alarm in some manner, by calling relatives, calling emergency numbers, or activating some type of distress button, but instead, instances that engender a sense of unease and fear that do not warrant calling the rescue agencies. There are large sectors of the population who are particularly vulnerable to such feelings: women, children, and the elderly. The option available to them today in dealing with these fears is to call (if they have a cellular telephone) acquaintances and risk the called person not being available, or being critical of his/her fears, or even ridiculing the caller, which may deter the person from using this option. And anyway, this solution has two key disadvantages. If something actually happens to the caller, the other party's ability to help is limited, both because the other party may not know the caller's exact location, and because the other party's link with the rescue agencies is indirect rather than direct.

The cellular accompaniment embodiment of the present invention relates to any person equipped with a cellular telephone calling a predetermined dial code and thereby asking for cellular accompaniment for a limited time until he/she has passed the frightening place, or until a suspicious noise has subsided. The system identifies the caller's location and tracks the caller until the caller reaches safe haven. Several types of accompaniment are possible, such as voice accompaniment for a limited time by one of the system operators. For example, the operator calls after an agreed time has elapsed to find out if everything is in order, by having the person ordering the service key in a code. Additional elements can be integrated in the system, such as software capable of identifying extreme fear, or a lie in the tone of voice, by making a comparison with the caller's voice recorded under normal circumstances, thereby preventing the utterance of the All Clear password under duress.

Likewise, the embodiments of the present invention protocol extend to a novel business model, in that should receiving a call from a communications device include a differentiation between ordinary transactions and financial transactions, then interrogating of the database can be refined to differentiate between the desired transaction type, as reflected in the eventual routing—as appropriate to the respective transaction specified.

Operational Variation 1

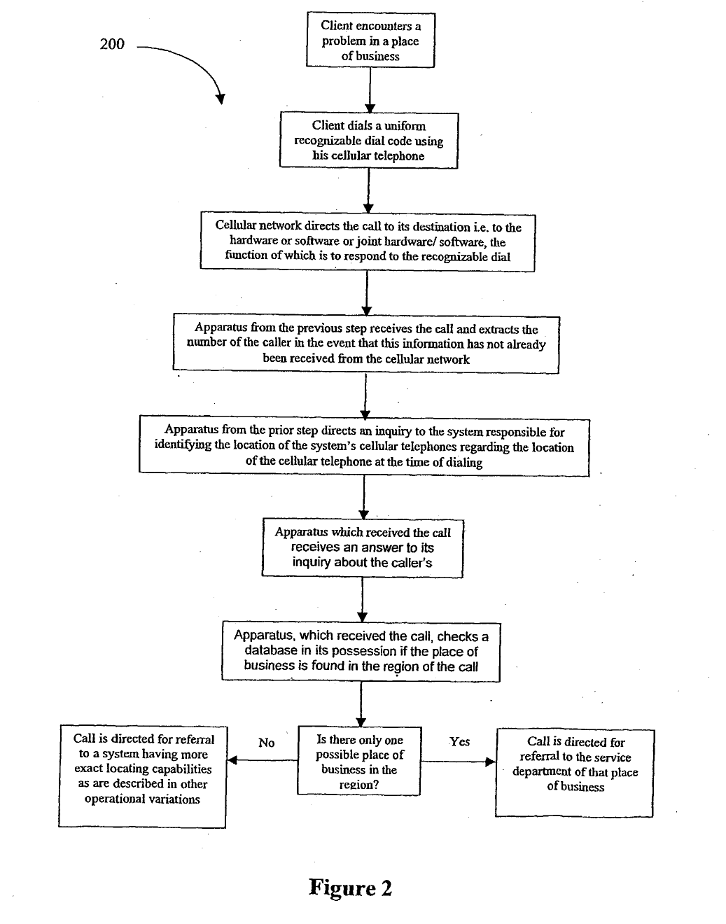

Turning to FIG. 2, which is a schematic flow chart representation of a system 200 for improving service to clients based on location identification when the system operates solely by using the locating capability of the cellular network itself without additional sensors. This type of system is efficient in cases of widely separated places of business such as gas stations.

Operational Variation 2

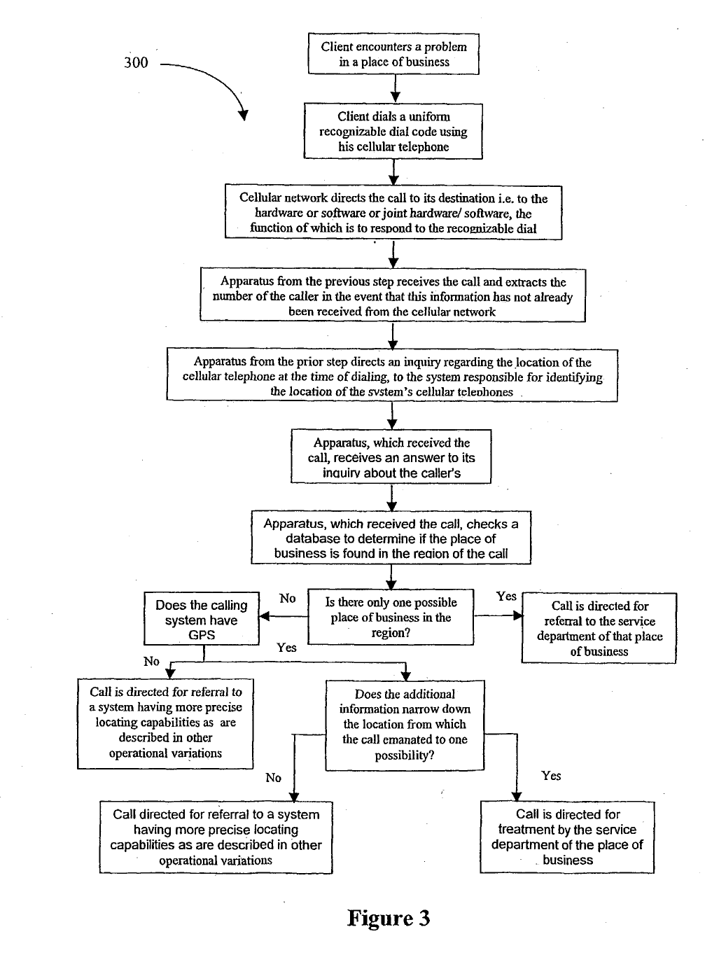

Turning now to FIG. 3, which is a schematic flow chart representation of a system 300 for improving service to clients, based on location identification, when the information received from the network about the location of the call is insufficient to identify the place of business, from which the client is calling. The system has the possibility of receiving additional information about the location of the call from a computer which stores data about the location of the caller received from a global positioning system (GPS) unit installed on the cellular telephone of the user. This data is also transferrable to the computer by the cellular network.

Operational Variation 3

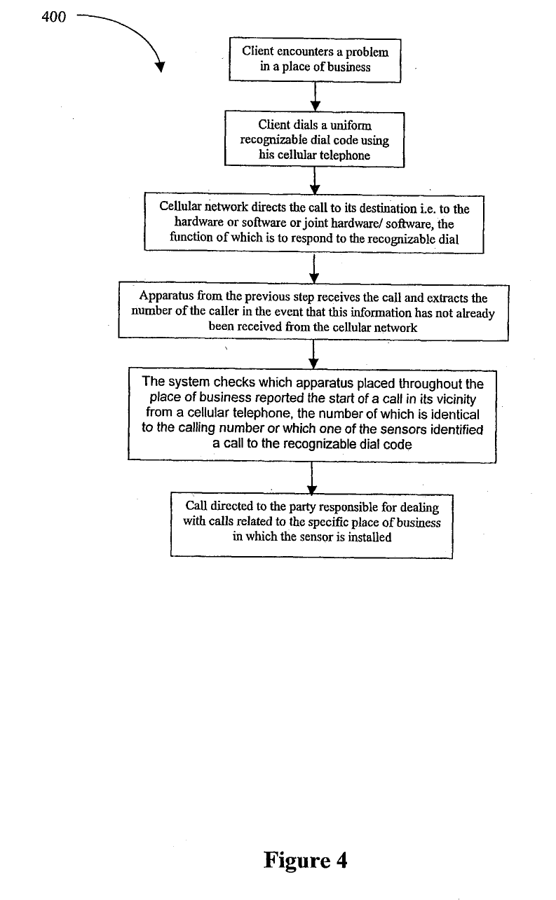

Turning now to FIG. 4, which is a schematic flow chart representation of a system 400, when there are local sensors capable of supplying additional information improving identification of the call location and transferring it to the system using a “smart” technology capable of deciphering the signals of the cell phone. Transmitting in its neighborhood and therefore capable of at least determining if there are cell phones in the neighborhood. Therefore the system receiving the information knows that a certain instrument is found in a certain place of business and when this instrument calls the speed number it knows where to direct the call.

Operational Variation 4

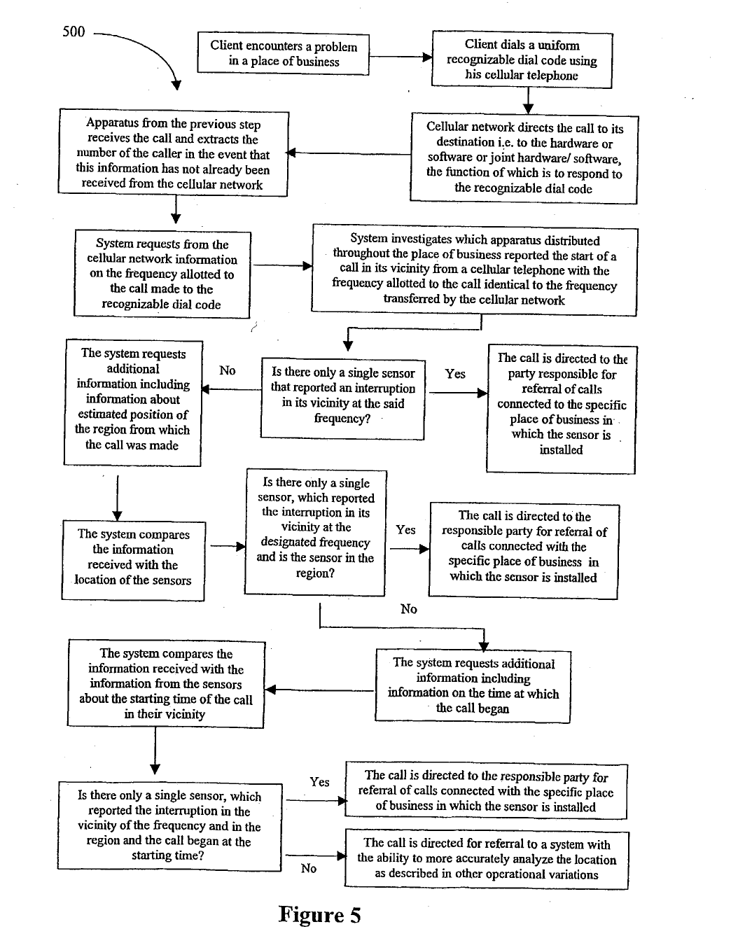

Turning now to FIG. 5, which is a schematic flow chart representation of a system 500, where the local sensors include a technology that do not decipher the transmissions but are capable of uncovering information on the nature of the transmissions performed in their vicinity. For example, the sensors identify when a cellular telephone call began, that is when there was an interruption in the transmission on one of the frequencies designated for cellular network transmission in their vicinity, including the ability to identify the exact frequency on which the interruption occurred. The system receives this information regarding when a cellular telephone call began. From the cellular network, the system further receives exact information about the number of the cellular telephone line which called the recognizable dial code and which frequency designated to the said cellular telephone. This information, combined with information from the sensor network regarding frequencies interrupted in their vicinity, will suffice to identify the place of business from which the client called and to direct the call to the correct place.

Operational Variation 5

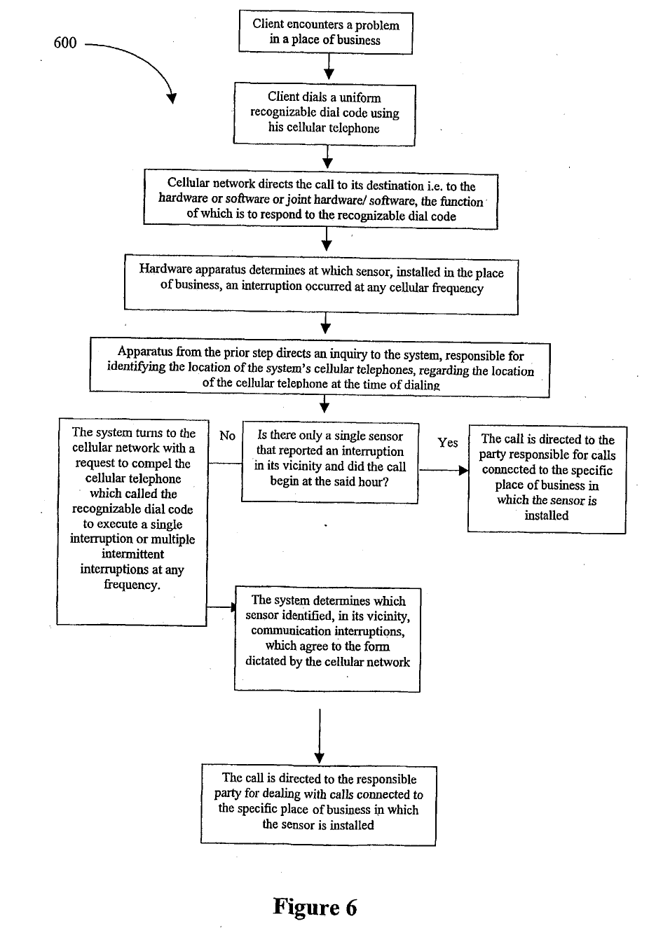

Turning now to FIG. 6, which is a schematic flow chart representation of a system 600, when the local sensors identify only an interruption in transmission in the vicinity of the sensors, at frequencies designated for cellular communications. In addition, the sensors register the time the transmission began. All the abovementioned data is transferred to the system and the system receives from the cellular phone network, the starting time of the call to the recognizable dial code and the general location from which the call emanated. The system determines the vicinity of the sensor from which a call emanated at the exact time in which the call to the recognizable dial code occurred. In the event that there is only one location from which such a call emanated at the precise time that the transmission began, the call is directed to the service department of the place of business. In the event that there is more than one place, from which a call began at that very same time, the systems described in the following Operational Variations are used to assist.

Operational Variation 6

With regard to this operational variation, information concerning the client is received by a human operator inquirer regarding the client's location. The client supplies information apropos the client's exact location, including, for example, the branch of the commercial chain in which he is located.

Operational Variation 7

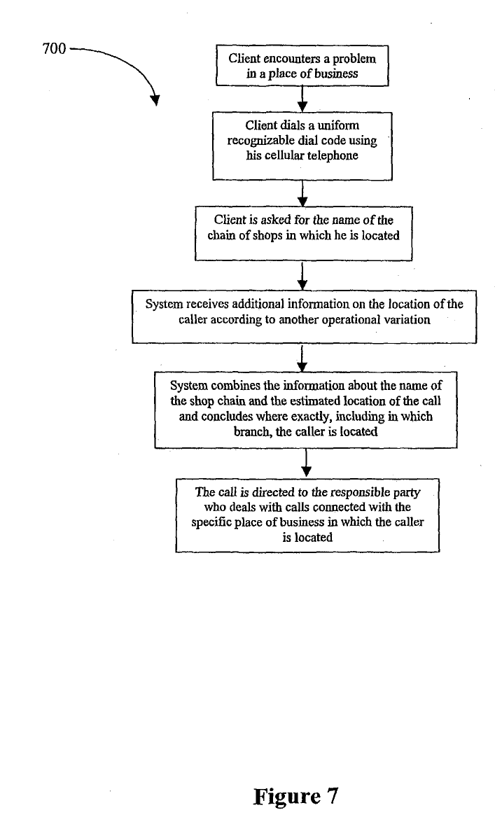

Turning now to FIG. 7, which is a schematic flow chart representation of a system 700 wherein the client transmits only general information, for example, regarding the client's location in a chain of shops such as McDonalds. However, the client does not identify the branch of the chain in which he is located. If the system receives additional information about the location of the call from one of the sources, mentioned in previous Operational Variations, the system combines this location information with the information identifying the chain of shops received from the client. The result is that only a single possible branch exists from where the call was made based on the data received, because there is only a single branch of the chain in that region.

Operational Variation 8

With respect to this operational variation, the client is not answered by a human but by a digital voice recording, which requests that the client choose a selection by pressing a suitable key. For example, the digital voice recording asks “If, you are located in the McDonalds branch on Ibn Givirol Street, push key 1”, “If you are in Domino's Pizzas on Ibn Givirol St., push key 2”, etc. The system narrows down the number of possible locations from which the client called by using additional data received by one of the systems described in the previous Operational Variations.

Operational Variation 9

According to this operational variation, the client is not answered by a digital voice recording but by a joint system, which also enables speech identification. In this case, the client is requested to provide full details about the location, the details provided in the client's own voice. Based on these details, the system directs the call to the appropriate location.

Operational Variation 10

With regard to this variation, the client is answered by a combined system The system identifies speech and the client transmits only the name of the chain in which the client is located. The system receives additional data about the location of the call using one of the methods described in the previous Operational Variations. The system identifies the location of the caller, for example, in which branch of a chain the caller is located, and thereafter transfers the call to the appropriate party.

Operational Variation 11

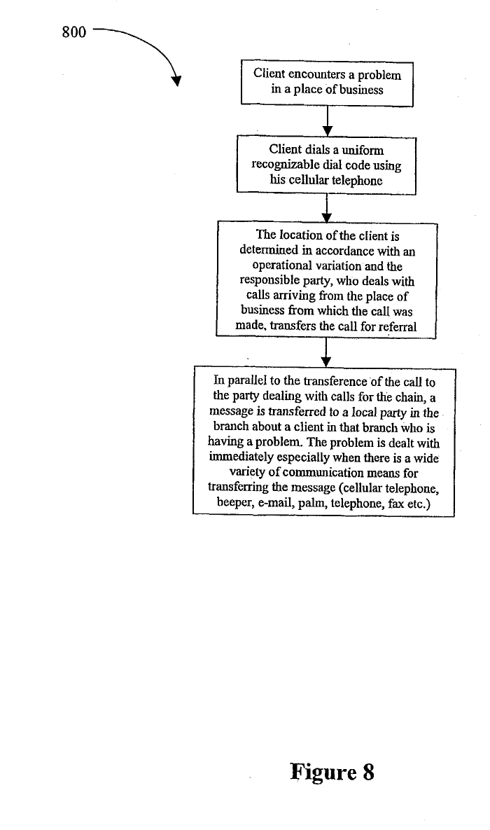

Turning now to FIG. 8, which is a schematic flow chart representation of a system 800, whereby, after identifying the location of the caller, the system directs the call for management by appropriate service personell. Furthermore, by an appropriate communication method, the system warns the local service person in the area of the caller. For example, a manager of the place of business, from which a call was made, deals with a problem directly, in so doing, saving the client time and trouble. The specific manager is responsible within a defined area to a service center of the chain.

Operational Variation 12

The system, according to the present variation, after identifying the location of the caller, forms a direct verbal connection between the responsible local customer service person, for example the store manager, and the client. This is effected, for example, by a conference call. A reason for this procedure is that the local customer service person easily locates the location of the caller. Locating a customer is a problem especially in large commercial establishments such as supermarkets, department stores, etc.

Operational Variation 13

An operational variation wherein the user is not inside a place of business, but is next to an automatic sales machine includes machines supplying services, for example a parking meter. The system serves to locate the specific machine from which the caller wishes to purchase an article or service. The machine is thereby enabled to remotely supply the user with an article or service by means of a command sent to the sales machine by an appropriate communication method.

Operational Variation 14

In this operational variation, the information concerning communications with each client is stored for future use. For example, the system is enabled to warn a service center that is in contact with a specifically problematic client who has previously contacted other service centers.

Operational Variation 15

Regarding this operational variation, the client is located inside a vehicle, for example a public transportation vehicle. Since vehicles are mobile, generally additional data will be required from the client or passenger in order to identify the location, for example, the bus line on which he is traveling.

Operational Variation 16

In this operational variation, active notification of the location of regional dangers is initiated by the system. The system continuously tracks the location of a cellular telephone by means of information received in accordance with previously described Operational Variations. When the system identifies that a cellular telephone is entering a dangerous area, a message is immediately sent as a human voice, recorded voice, a textual message, etc., describing the nature of the danger. Means are also suggested for avoiding a specific problem.

Operational Variation 17

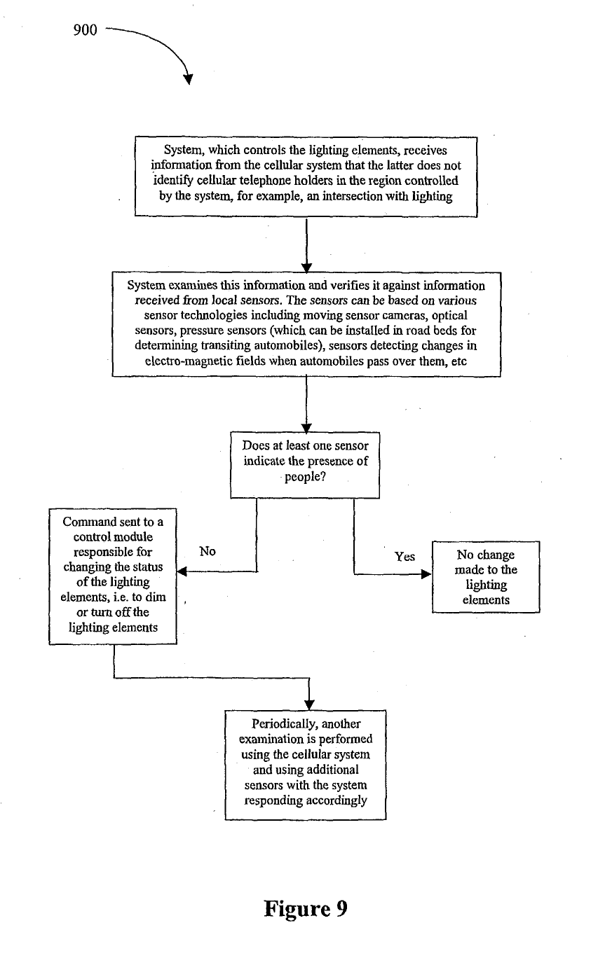

Turning now to FIG. 9, which is a schematic flow chart illustrating a system 900 as described in Operational Variation 16 but used to save electricity in a region or at times when there is little or no demand, for example, for lighting. The system controls the lighting elements from a distance by an appropriate communication means such as cellular telephone, wireless communications, communications using an electricity network, orientation on high voltage wires, etc. Hence, the lighting is increased, decreased or shut-off in public areas such as roads, intersections, industrial zones, public structures, etc. or in private places such as warehouses, military structures, governmental structures etc. In the regions in which the lighting operates, the system changes the state of the lighting elements according to information received regarding the presence or absence of people.

Operational Variation 18

The system, in accordance with this variation, serves to examine prior information about vehicles carrying cargo and merchandise. The system compares the information to other data received, whether visually or according to other physical activities occurring in the vicinity of the vehicle.

Operational Variation 19

The system serves as cellular accompaniment for people experiencing temporary states of concern based on their location, for example when traversing a dark area and when accompaniment is performed by a paid human escort.

Operational Variation 20

The system, according to this variation, as described in Operational Variation 19, is performed by an automatic system, which also uses physical verification, such as activating a specific warning or at ease button

Operational Variation 21

This operational variation system serves as a cellular telephone accompaniment and is combined with a voice and speech identification system, which identifies unusual voices, indicating that the user is in danger.

Notice:

In describing the present invention, explanations are presented in light of currently accepted Technological, ergometric or data-communications theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

Likewise, the present invention has been described with a certain degree of particularity, however those versed in the art will readily appreciate that various modifications and alterations may be carried out without departing from either the spirit or scope; as hereinafter claimed.

1. A location based service data-communications protocol including:
i) receiving a call from a communications device
ii) discerning location-relevant information about a present location-cell of the communications device using means for increasing an amount of information about a precise location of the communications device, and said means is selected from the list voice recognition, automated query and keypad response, and special device;
iii) by interrogating a database facility, finding at least one authorized support authority for the present location-cell; and
iv) routing the call to a support authority selected from the at least one support authority.
v) The location based service data-communications protocol according to claim 1 wherein the communications device is a wireless communications device.
vi) The location based service data-communications protocol according to claim 1 wherein the wireless communications device is selected from the list: cellular telephone, cordless telephone, pager, personal data assistant.

2. The location based service data-communications protocol according to claim 1 wherein the communications device is a standard stationary location installed telephone.

3. The location based service data-communications protocol according to claim 1 wherein the communications device is a standard stationary location installed computer.

4. The location based service data-communications protocol according to claim 1 wherein Discerning location-relevant information about a present location-cell of the communications device includes applying means for improving the location accuracy.

5. The location based service data-communications protocol according to claim 1 wherein receiving a call includes accepting a service selection operational variation request and wherein finding the at least one support authority includes convoluting parameters of the finding with the service selection operational variation request.

6. The location based service data-communications protocol according to claim 1 wherein routing the call includes transmitting at least one control command to a peripherally related service system.

7. The information based service data-communications protocol according to claim 1 wherein routing the call includes transmitting at least one query to a peripherally related service system.

8. An article of manufacture including a computer usable medium having computer readable program code embodied therein for facilitating a location based service data-communications protocol transaction, the computer readable program code in said article of manufacture including:
i) first computer readable program code for causing a computer to receive a call from a communications device;
ii) tied to the first computer readable software, second computer readable program code for causing the computer to discern location-relevant information about a present location-cell of the communications device using means for increasing an amount of information about a precise location of the communications device, and said means is selected from the list: voice recognition, automated query and keypad response, and special device;
iii) tied to the second computer readable software, third computer readably program code for causing the computer to find at least one authorized support authority for the present location-cell by interrogating a database facility; and
iv) tied to the third computer readable software, fourth computer readable program code for causing the computer to route the call to a support authority selected from the at least one support authority.

9. A program storage device readable by machine, tangibly embodying a program of instructions executable by the machine to perform method steps for a location based service data-communications protocol including, said method steps including:
i) receiving a call from a communications device;
ii) discerning location-relevant information about a present location-cell of the communications device using means for increasing an amount of information about a precise location of the communications device, and said means is selected from the list voice recognition, automated query and keypad response, and special device;
iii) by interrogating a database facility, finding at least one authorized support authority for the present location-cell; and
iv) routing the call to a support authority selected from the at least one support authority.
